(19) United States
(12) Patent Application Publication
(10) Pub. No.: US 2003/0213125 A1
(43) Pub. Date: Nov. 20, 2003

(54) Ball valve body manufacturing method

(76) Inventor: Su-Yueh Chiuchang, Taichunag (TW)

Correspondence Address: ERIK M. ARNHEM, 4250 Wilshire Blvd., Second Floor, Los Angeles, CA, 90010, US

(21) Appl. No.: 10/151,329

(22) Filed: May 20, 2002

(51) Int. Cl. B23K 1/20; B23K 17/00; B21K 1/20

(52) U.S. Cl. 29/890.126

(57) ABSTRACT

A ball valve body manufacturing method is disclosed. The method comprises rolling a continuous metal tube to form a series of connected ball valve body blanks by roller means, punching or milling the blanks to form at least one valve stem fastening slot thereon, rubbing or polishing surfaces of the blanks to form substantially rounded surfaces, and cutting the blanks into a plurality of ball valve bodies each having two opposite openings in communication each other.

### BACKGROUND OF THE INVENTION

1. Field of the Invention

The present invention relates to ball valve body manufacturing process and more particularly to a ball valve body manufacturing method with improved characteristics.

2. Description of the Prior Art

Conventionally, ball valve bodies are manufactured by casting. Such produced ball valve bodies are undesirable because there are holes therein. For solving the problem, typically a diameter of a ball valve body blank is about one and half times of that of the manufactured ball valve body. In other words, excessive material is wasted in a rubbing process of the ball valve body blanks. Further, such process is time consuming. To the worse, a yield of ball valve bodies manufactured by the casting is only about 30% to 50%. This in turn increases a manufacturing cost.

Another conventional process for manufacturing ball valve bodies is by pressing or forging two mating half ball valve bodies which are joined together to form a ball valve body by soldering or welding thereafter. The formed ball valve bodies are further polished to desirable ones. Such is disadvantageous because of time consuming, less structural strength as compared with the integrally formed one, a high machining precision required for joining the half ball valve bodies together, and low yield.

Still another conventional process for manufacturing ball valve bodies is by punching a portion of a continuous metal tube material into a ball valve body blank having two opposite openings in communication each other and a surface slot for fastening a valve stem, shaping the openings to form two fluid channels, and rubbing or polishing a surface of the ball valve body blank to form a substantially rounded surface. Such is still disadvantageous because only a single ball valve body is formed at one punching process. In other words, a mass production in a short period of time is impossible, resulting in low yield and efficiency.

Thus, it is desirable to provide an improved ball valve body manufacturing method in order to overcome the above drawbacks of prior art.

### SUMMARY OF THE INVENTION

It is an object of the present invention to provide a ball valve body manufacturing method comprising (a) rolling a continuous metal tube material to form a series of connected ball valve body blanks by rolling means, (b) punching or milling the blanks to form at least one valve stem fastening slot thereon, (c) rubbing or polishing surfaces of the blanks to form substantially rounded surfaces, and (d) cutting the blanks into a plurality of ball valve bodies each having two opposite openings in communication each other. By utilizing this method, it is possible of effecting a mass production, reducing manufacturing cost, and improving yield.

In one aspect of the present invention, further comprises the step of forming an internal cylindrical metal section for connecting the openings of the ball valve body.

### BRIEF DESCRIPTION OF THE DRAWINGS

The drawings disclose an illustrative embodiment of the present invention which serves to exemplify the various advantages and objects hereof, and are as follow:

FIG. 1 is a cross-sectional view showing a continuous metal tube material being manufactured into ball valve bodies by a method according to the invention;

FIGS. 2A to 2C are side views in part section showing sub-steps of rolling a ball valve body blank of FIG. 1;

FIGS. 3A and 3B are cross-sectional views showing sub-steps of forming a valve stem fastening slot in a first preferred embodiment;

FIG. 4 is a cross-sectional view showing the step of forming the valve stem fastening slot in a variation of the first preferred embodiment;

FIGS. 5A to 5C are cross-sectional views showing steps of cutting, rubbing and polishing ball valve body blanks for forming ball valve bodies;

FIG. 6 is a cross-sectional view showing a ball valve formed by the first preferred embodiment; and

FIG. 7 is a cross-sectional view showing a ball valve formed by a second preferred embodiment.

### DETAILED DESCRIPTION OF THE PREFERRED EMBODIMENTS

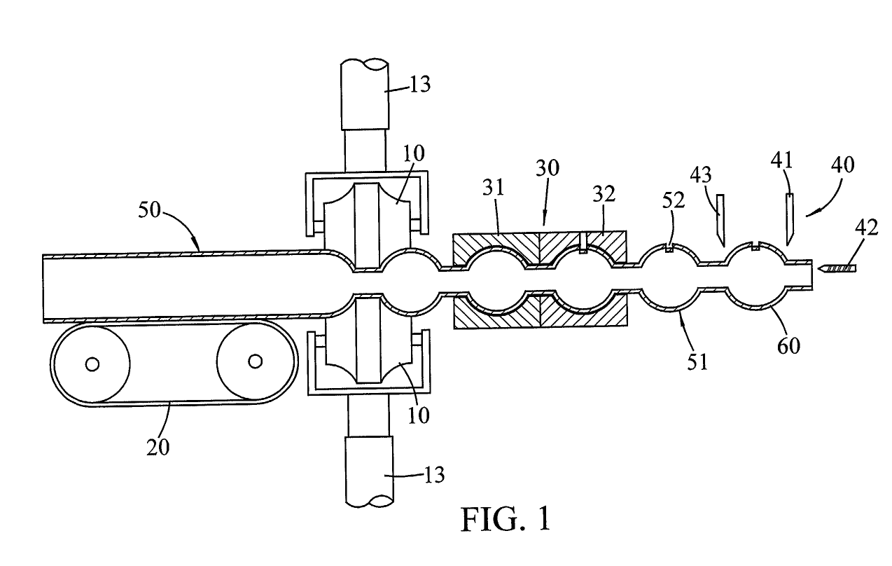

Referring to FIG. 1, there is shown a ball valve body manufacturing process according to the invention. The process comprises steps of (a) rolling a continuous metal tube material 50 to form a series of connected ball valve body blanks 51 by a rolling device 10; (b) punching or milling the blanks 51 to form at least one valve stem fastening slot 52 thereon; (c) rubbing or polishing surfaces of the blanks 51 to form substantially rounded surfaces; and (d) cutting the blanks 51 into a plurality of ball valve bodies 60 each having two opposite openings in communication each other. Each of above steps will now be described in detail below.

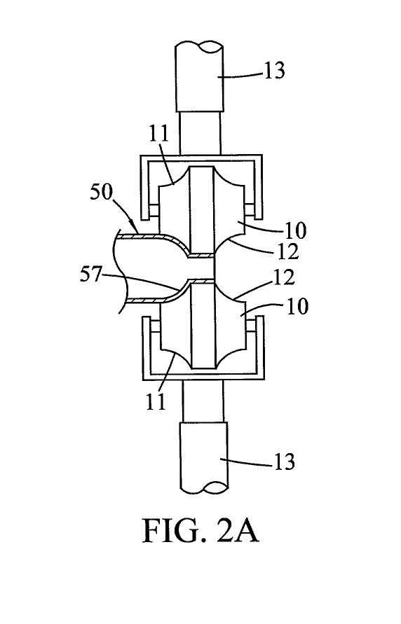

Referring to FIGS. 2A to 2C, there are shown sub-steps of rolling the continuous metal tube material 50 to form a series of connected ball valve body blanks 51 by a rolling device 10 including a pair of opposite roller 11, 12. In FIG. 2A, conveyor means 20 is first utilized to continuously transfer the tube material 50 to a desired place for manufacturing. Then two opposite hydraulic cylinders 13 are actuated to move the rollers 11, 12 toward each other. In response, a cross-section of the tube material 50 is reduced and a first half circular surface 57 is formed by two first arcuate surfaces 11 of the rollers 11, 12. Next, as shown in FIGS. 2B and 2C, the rollers 11, 12 move away each other and move toward each again to reduce the cross-section of the tube material 50 again and form a second half circular surface 58 by two second arcuate surfaces 12 of the rollers 11, 12. As a result, the first and second half circular surfaces 57, 58 form one of a series of connected and communicated ball valve body blanks 51 wherein any two adjacent ball valve body blanks 51 are coupled by a tube section having a reduced diameter as compared with the tube material 50.

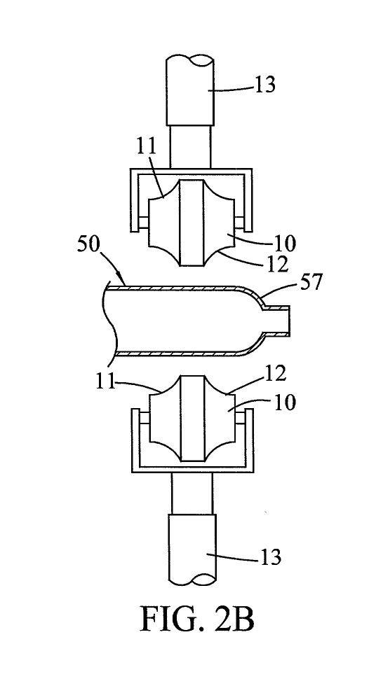

Referring to FIGS. 3A and 3B, there are shown sub-steps of forming the valve stem fastening slot 52 in a first preferred embodiment. At this time, the ball valve body blanks 51 are transferred to a place between two pairs of opposite fixing dies 31 and punching dies 32 of a valve stem fastening slot device 30 (FIG. 3A). Then, the pairs of opposite fixing dies 31 and punching dies 32 are actuated to move toward each other. At this time, the conveyor means 20 is halted temporarily. In response, the pairs of opposite fixing dies 31 and punching dies 32 can fix one blank 51 and punch a previous blank 51 to form at least one valve stem fastening slot (one is shown) 52 respectively (FIG. 3B). Finally, the conveyor means 20 is actuated again to continuously transfer the tube material 50. At the same time, the pairs of opposite fixing dies 31 and punching dies 32 are actuated to move away each other. As a result, the half-finished blanks are transferred to a next stage.

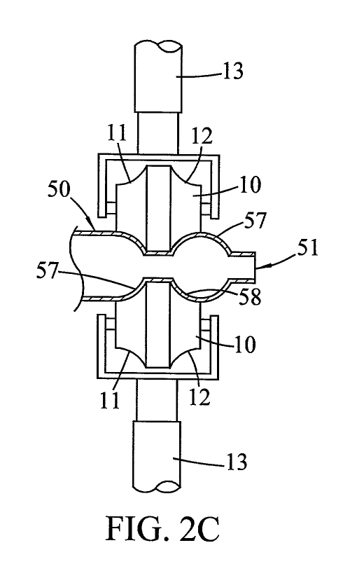

Referring to FIG. 4, there is shown the step of forming the valve stem fastening slot 52 in a variation of the first preferred embodiment wherein the punching dies 32 of the first preferred embodiment are replaced by at least one milling cutter (one is shown) 33 for forming at least one valve stem fastening slot 52.

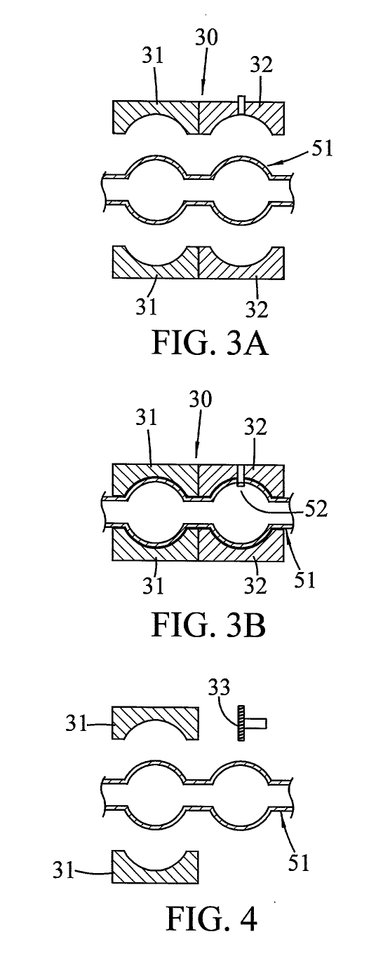

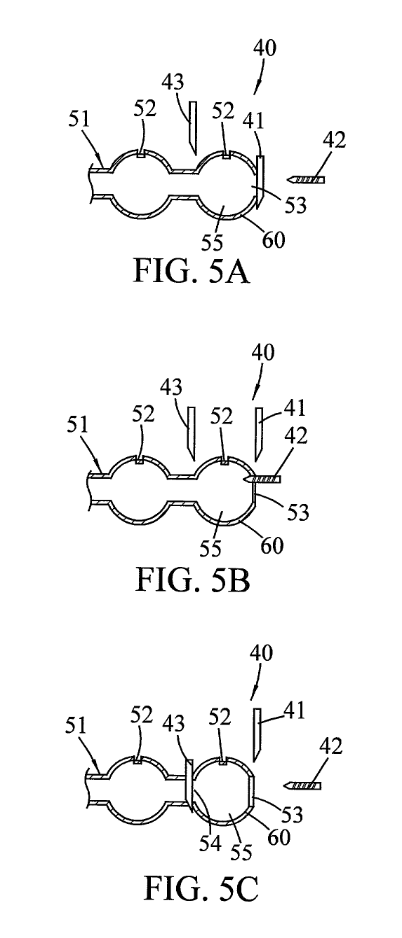

Referring to FIGS. 5A to 5C, the steps of cutting, rubbing and polishing ball valve body blanks 51 are illustrated. In the manufacturing processes, there is further provided a cutting and rubbing device 40. The cutting and rubbing device 40 has a first cutter 41 first cutting the front tube section of the front-most blank 51 to form a front opening 53 which is in communication with a fluid channel 55; and a NC (Numerical Control) second cutter 42 (or replaced with a cutter of polishing device) for rubbing or polishing a surface of the front-most blank 51 to form a substantially rounded surface; and a third cutter 43 for cutting the rear tube section of the front-most blank 51 to separate the front-most blank 51 from the rest of the blanks 51 so as to form a ball valve body 60 further having a rear opening 54 which is in communication with the fluid channel 55. Referring to FIG. 6, there is shown a formed ball valve body 56 formed by the first preferred embodiment having front and rear openings 53, 54 and a fluid channel 55 therebetween.

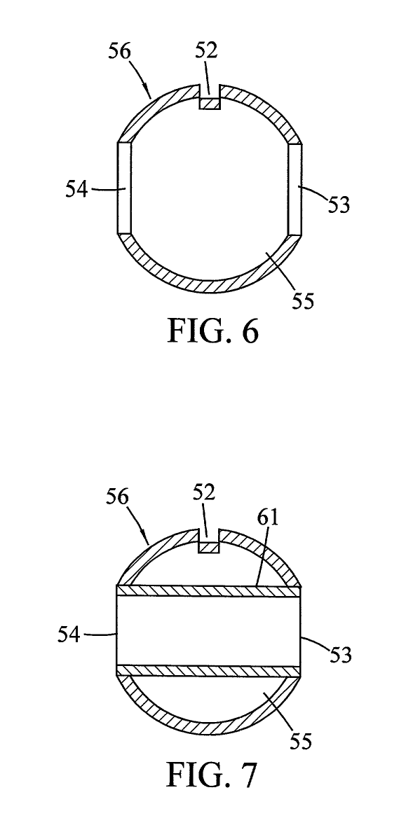

Referring to FIG. 7, there is a cross-sectional view showing a ball valve body 56 formed by a second preferred embodiment wherein an internal cylindrical metal section 61 is formed to connect the front and rear openings 53, 54 by soldering or welding. The internal cylindrical metal section 61 serves to provide a guide channel for facilitating a flow of fluid through the ball valve body 56.

The benefits of this invention include effecting a mass production, reducing manufacturing cost, and improving yield.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A ball valve body manufacturing method comprising the steps of:
(a) rolling a continuous metal tube material to form a series of connected ball valve body blanks by rolling means;
(b) forming the blanks to form at least one valve stem fastening slot thereon;
(c) smoothing surfaces of the blanks to form substantially rounded surfaces; and
(d) cutting the blanks into a plurality of ball valve bodies each having two opposite openings in communication each other.

2. The method of claim 1, wherein the forming step (b) is done by punching.

3. The method of claim 1, wherein the forming step (b) is done by milling.

4. The method of claim 1, wherein the smoothing step (c) is done by rubbing.

5. The method of claim 1, wherein the smoothing step (c) is done by polishing.

6. The method of claim 1, further comprising the step of forming an internal cylindrical metal section for connecting the openings.
